(19) United States
(12) Patent Application Publication
(10) Pub. No.: US 2023/0398391 A1
(43) Pub. Date: Dec. 14, 2023

(54) AUTOMATED FIRE SUPPRESSION SYSTEM

(71) Applicant: Gregory James Owsley, Sacramento, CA (US)

(72) Inventor: Gregory James Owsley, Sacramento, CA (US)

(21) Appl. No.: 17/806,548

(22) Filed: Jun. 13, 2022

(51) Int. Cl. A62C 37/40; A62C 3/02

(52) U.S. Cl. CPC A62C 37/40; A62C 3/0214

(57) ABSTRACT

An automated roof sprinkler fire suppression system is disclosed. The system responds to heat and smoke around an exterior perimeter of the structure and supplies pressure during low municipal pressures without depleting fire hydrant pressures. The system includes multiple sprinkler heads disposed on a roof of the structure and optional additional sprinkler heads on a sidewall of the structure. A conduit communicates a water source with the multiple sprinkler heads to douse the roof and exterior of the building with water to prevent heat and embers from igniting the structure.

### BACKGROUND OF THE INVENTION

The present invention relates to fire protection, and more particularly to automated fire suppression systems.

This system solves the problem of leaving a building unprotected during evacuation from a nearby fire while the fire department is not at the scene.

Other fire sprinklers are inside the building beneath the roof, and they depend upon water main pressure onto the property. But this system provides pressure from a reserve tank on the property filled in advance, and it sprays water over the outside of the roof.

Other fire suppression systems are usually activated by conditions inside the building or structure protected by the fire suppression system. These systems are oblivious to conditions outside the building and along the property lines.

Likewise, other fire suppression systems rely on municipal water supplies. However, during significant fire activity, low municipal pressures and depletion of fire hydrant pressures may occur.

As can be seen, there is a need for an improved fire suppression system that is operational without occupant intervention and without depleting municipal water sources to combat fires in a structure.

### SUMMARY OF THE INVENTION

In one aspect of the present invention, an automated fire suppression system for an exterior of a structure is disclosed. The automated fire suppression system includes multiple sprinkler heads deployed in a spaced apart relation about a roof of the structure. A conduit interconnects the multiple sprinkler heads to deliver a source of water to douse the roof of the structure. A water containment reservoir is in communication with the conduit. A pump is selectively operable to pressurize a source of water contained within the water containment reservoir for delivery to the multiple sprinkler heads. A plurality of smoke and thermal sensors is provided for deployment about the exterior of the structure. A controller is configured to activate the pump on detection of one or more of a smoke and a thermal event by the plurality of smoke and thermal sensors.

In some embodiments, multiple additional sprinkler heads are deployed in a spaced apart relation along a sidewall of the structure.

In some embodiments, an input control valve is selectively operable by the controller to fill the water containment reservoir via a water main associated with the structure.

In some embodiments, one or more thermal sensors are deployed on the roof of the structure.

In some embodiments, a solar generator is included to charge a battery source for powering one or more of the pump, the controller, and the plurality of smoke and thermal sensors.

In other aspects of the invention, a fire suppression system for an exterior of a structure is disclosed. The fire suppression system includes multiple sprinkler heads deployed in a spaced apart relation about a roof of the structure. A conduit interconnects the multiple sprinkler heads to deliver a source of water to douse the roof of the structure. A water outlet valve is operable to communicate a source of water to the conduit. A plurality of smoke and thermal sensors is provided for deployment about the exterior of the structure. A controller is configured to activate the water outlet valve on detection of one or more of a smoke and a thermal event by the plurality of smoke and thermal sensors.

In some embodiments, multiple additional sprinkler heads are deployed in a spaced apart relation along a sidewall of the structure. Each of the multiple additional sprinkler heads are in communication with the conduit.

In some embodiments, the source of water comprises a water main servicing the structure.

In other embodiments, a water containment reservoir is in communication with the water main and the conduit.

In some embodiments, an input shutoff valve is interposed between an inlet of the water containment reservoir and the water main. The input shutoff valve is operable by the controller to selectively fill the water containment reservoir from the water main.

In yet other embodiments, one or more thermal sensors deployed on the roof of the structure.

These and other features, aspects and advantages of the present invention will become better understood with reference to the following drawings, description and claims.

### BRIEF DESCRIPTION OF THE DRAWINGS

FIG. 1 is a schematic view of the automated fire suppression system;

FIG. 2 is a schematic detailed view of the above ground automated fire suppression system;

FIG. 3 is a schematic detailed view of the underground automated fire suppression system;

FIG. 4 is a schematic side view of the automated fire suppression system; and

FIG. 5 is a schematic top view of the automated fire suppression system.

### DETAILED DESCRIPTION

The following detailed description is of the best currently contemplated modes of carrying out exemplary embodiments of the invention. The description is not to be taken in a limiting sense but is made merely for the purpose of illustrating the general principles of the invention.

Broadly, embodiments of the present invention provide an automated fire suppression system for an exterior of a structure or a dwelling. The system is self-contained in that it is not reliant on a municipal water source.

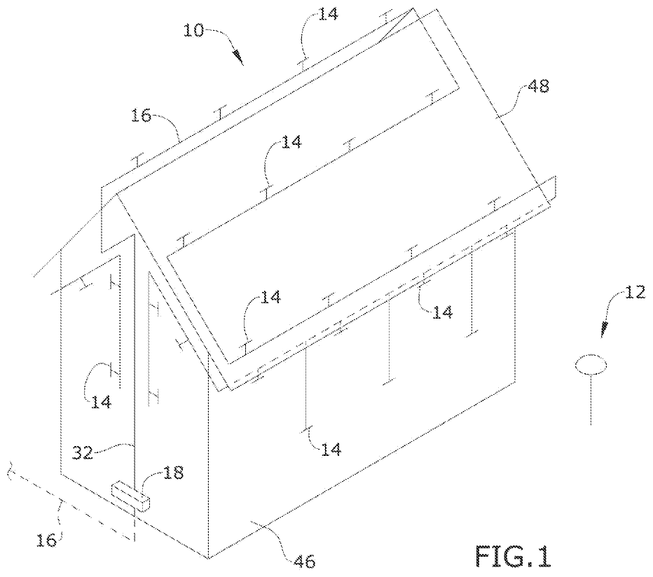

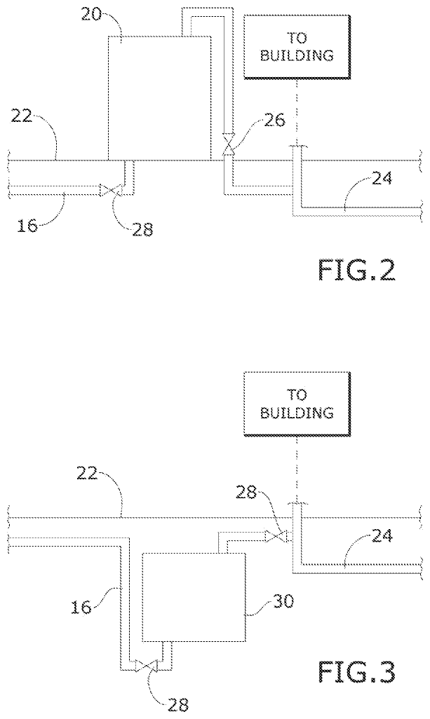

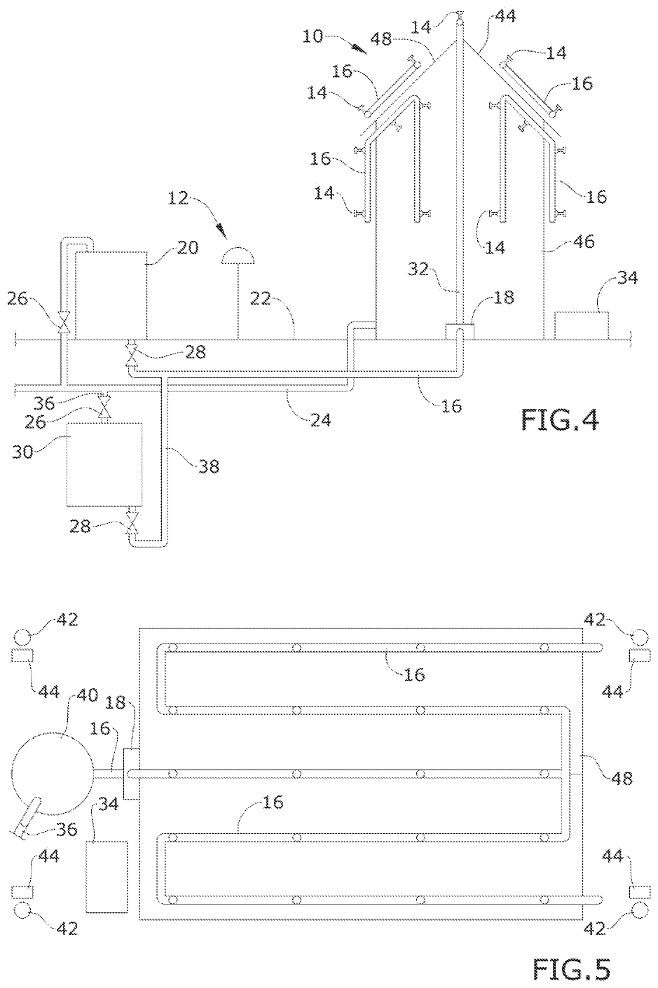

Non-limiting embodiments of the automated fire suppression system 10 are shown in reference to the drawings of FIGS. 1-5. The automated fire suppression system 10 includes a plurality of smoke and thermal sensors 12 that may be deployed about a property line of a dwelling 46. Multiple sprinkler heads 14 are disposed in a spaced apart relation on a roof 48 and a sidewall of the dwelling 46. The multiple sprinkler heads 14 are configured to emit a spray of water to cover the entire roof 48 of the structure 46 and an upper part of the sidewalls of the dwelling 46. A conduit 16 delivers a source of water to the multiple sprinkler heads 14. A riser line 32 is operatively connected with a water pump 18 which may be mounted on the dwelling 46 or may be positioned proximal to a water containment reservoir 20, 30.

The water containment reservoir 20, 30 may be an above-ground tank 20 supported by a ground surface 22 and an in-ground tank 30 buried beneath the ground surface 22. Each water containment reservoir 20, 30 may be filled by a water supply line 24 coupled with a water main servicing the dwelling 46. An intake valve 26 is operable to selectively receive a source of water from the water main to fill the water containment reservoir 20, 30. An output valve 28 is operable to deliver a source of water contained within the water containment reservoir 20, 30 and convey the source of water to the water pump 18 for subsequent delivery to the multiple sprinkler heads 14. The multiple sprinkler heads 14 may utilize a landscaping sprinkler with adjustable sprinkler fans so that water emitted may be directed to the structure 46. As will be appreciated, the sprinkler heads could be activated individually, based on the thermal signature, or operated simultaneously to cover the entire dwelling 46.

A generator 34 is provided as an electrical source to power the pump 18 and sensors 12. The generator 34 may be a solar powered battery storage generator.

The plurality of smoke and thermal sensors 12 are monitored by a control panel (not shown). The smoke and thermal sensors 12 may be integrally formed sensors. Alternatively, a thermal sensor 42 and a thermal sensor 44 may be deployed as individual components deployed about a perimeter of the structure 46. Additional thermal sensors 44 may be deployed on the roof 48 of the structure 46.

The control panel sensing the automated heat and smoke sensors 12 activates the system 10 and powers the pump 18 to pressurize the sprinkler heads 14 located along the peak of the roof 44 and along the entire roof line on the outside of the building structure to deliver water from one of the water containment reservoirs 20, 30. The water douses the roof 48 and siding continuously with water to prevent embers, flames, and heat from igniting the structure 46.

The claimed invention differs from what currently exists. This invention is an improvement on what currently exists. Other fire sprinklers are inside the building beneath the roof, and they depend upon water main pressure onto the property. But this system provides pressure from water containment reservoir 20, 30 on the property that is filled in advance. Often fire sprinklers react to conditions too late in the process and, because they are reliant on municipal water sources, are subject to municipal water pressure fluctuations.

This automated sprinkler system 10 responds to heat and smoke beyond the outside of the structure 46 and supplies pressure during low municipal pressures without depleting fire hydrant pressures. Because the automated sprinkler system 10 operates autonomously, no one needs to stay behind to water down their roofs with a garden hose.

With the automated sprinkler system 10 deployed on a property, as a fire approaches the perimeter of the property, the deployed smoke detectors 42 and/or the thermal sensors 44 activate the pump 18 to pressurize the sprinkler heads 14 to spray water over the entire roofline on the structure 46 for the duration of the fire event or until the smoke and heat subside. If the smoke and heat sensors 12 are damaged and incapacitated, the detectors 12 cannot produce an off signal to deactivate the system. As such the system could continue spraying until the water supply is depleted and the intake pressure falls below a preset level.

When the atmospheric smoke or heat at the perimeter increase above a preset level, then the smoke 42 and thermal sensors 44 send electronic signals to the controller that then relays the activation signal to pressurize the system 10 output by the pump 18. If the supply line volume drops below a preset pressure, then the inlet valve 28 closes to prevent low municipal fire hydrant pressures. If supply from the water containment reservoir 20, 30 is interrupted then the output valve 26 will shut off the water pump 18.

The output pressure valve 28, conduits 16, and sprinkler heads 14 are necessary. But the water containment reservoir 20, 30 and automated sensor relays 12 are optional. The power source is also discretionary. The system 10 could be activated manually and supplied directly from any water main 24 serving the property 46. The water storage tank could be either buried or above ground and could also be connected for other uses inside the structure or outside elsewhere on the property. The sprinkler head 14 line along the peak of the roof 48 is necessary to prevent hot embers from landing on the roof 48, but the siding sprinklers 14 are optional to cool the outside of the structure 46 from intense heat.

The water containment reservoir 20, 30 could be above ground or buried under ground. More than one storage tank could be used in series or in parallel. Without the tank the system could be combined with the landscape sprinklers which could be activated either with the same sensors or with separate sensors, or manually. Structure sprinklers 14 under the eves and along the siding should be included for additional protection. The storage tank(s) should be composed of plastic, composite, or stainless steel. (The lining of the tank should be either stainless steel or glass to be used as a potential drinking water source.) Water filters (not shown) could be included in line before or after the water containment reservoir 20, 30.

As will be appreciated, the entire system 10 is fully automated after installation. The only requirements are maintenance and testing. However, if a manual version is utilized instead, then the person would need to identify the threat and open the output control valve 28 to activate the system 10 and close the output control valve 28 to deactivate the system. Manual operation may also include a switch to activate the pump 18, instead of depending upon the sensors 12.

It should be understood, of course, that the foregoing relates to exemplary embodiments of the invention and that modifications may be made without departing from the spirit and scope of the invention as set forth in the following claims.

What is claimed is:

1. An automated fire suppression system for an exterior of a structure, comprising:
multiple sprinkler heads deployed in a spaced apart relation about a roof of the structure;
a conduit interconnecting the multiple sprinkler heads to deliver a source of water to douse the roof of the structure;
a water containment reservoir connected with the conduit;
a pump selectively operable to pressurize a source of water contained within the water containment reservoir for delivery to the multiple sprinkler heads;
a plurality of smoke and thermal sensors for deployment about the exterior of the structure; and
a controller configured to activate the pump on detection of one or more of a smoke and a thermal event by the plurality of smoke and thermal sensors.

2. The automated fire suppressions system of claim 1, further comprising:
multiple additional sprinkler heads deployed in a spaced apart relation along a sidewall of the structure.

3. The automated fire suppression system of claim 1, further comprising:
an input control valve selectively operable by the controller to fill the water containment reservoir via a water main associated with the structure.

4. The automated fire suppression system of claim 1, further comprising:
one or more smoke and/or thermal sensors deployed on the roof of the structure and/or along the perimeter of the property line.

5. The automated fire suppression system of claim 1, further comprising:
a solar generator to charge a battery source for powering one or more of the pump, the controller, and the plurality of smoke and thermal sensors.

6. A fire suppression system for an exterior of a structure, comprising:
multiple sprinkler heads deployed in a spaced apart relation about a roof of the structure;
a conduit interconnecting the multiple sprinkler heads to deliver a source of water to douse the roof of the structure;
a water outlet valve operable to communicate a source of water to the conduit;
a plurality of smoke and thermal sensors for deployment about the exterior of the structure; and
a controller configured to activate the water outlet valve on detection of one or more of a smoke and a thermal event by the plurality of smoke and thermal sensors.

7. The fire suppressions system of claim 6, further comprising:
multiple additional sprinkler heads deployed in a spaced apart relation along a sidewall of the structure, each of the multiple additional sprinkler heads in communication with the conduit.

8. The fire suppression system of claim 6, wherein the source of water comprises a water main servicing the structure.

9. The fire suppression system of claim 8, further comprising:
a water containment reservoir in communication with the water main.

10. The fire suppression system of claim 9, further comprising:
an input shutoff valve interposed between an inlet of the water containment reservoir and the water main, the input shutoff valve operable by the controller to selectively fill the water containment reservoir from the water main.

11. The fire suppression system of claim 10, further comprising:
one or more thermal and/or smoke sensors deployed on the roof of the structure and/or along the perimeter of the property line.
